(19) United States
(12) Patent Application Publication
(10) Pub. No.: US 2004/0171971 A1
(43) Pub. Date: Sep. 2, 2004

(54) Powered antithrombotic foot mobility device with therapeutic massage

(75) Inventors: Sundaram Ravikumar, Briarcliff Manor, NY (US); John Rutkowski, Jackson, NJ (US)

Correspondence Address: David P. Gordon, Esq., 65 Woods End Road, Stamford, CT, 06905, US

(73) Assignee: Arvik Enterprises, LLC

(21) Appl. No.: 10/734,427

(22) Filed: Dec. 12, 2003

Related U.S. Application Data
(63) Continuation-in-part of application No. 10/021,219, filed on Oct. 29, 2001.

(51) Int. Cl. A61H 1/02; A61H 23/04

(52) U.S. Cl. 601/32; 601/105; 601/148; 601/152

(57) ABSTRACT

A foot mobility device includes a base, a foot rest hingedly coupled to the base, and an inflatable lifting bladder between the base and the foot rest. The footrest preferably has a massage sock which contains a plurality of inflatable massage bladders. Each of the bladders is provided with a pressure sensor and is selectively coupled to a pressure source (including an air pump) by an electrically operated valve. A control circuit is electrically coupled to the valves, the sensors, and the pump. The control circuit selectively inflates and deflates the bladders according to a cycle which raises and lowers the foot rest and inflates/deflates the massage bladders. The control circuit is preferably provided with a synchronization link which is used to electrically couple two foot mobility devices (one for each foot) such that they operate in an alternating rhythm.

The application is a continuation-in-part of Ser. No. 10/021,219, filed Oct. 29, 2001, entitled “Powered Antithrombotic Foot Mobility Device”, which is hereby incorporated by reference herein in its entirety.

### BACKGROUND OF THE INVENTION

1. Field of the Invention

This invention relates broadly to exercise devices. More particularly, this invention relates to exercise devices which promote circulation in the lower extremities by movement of the foot about a pivot and by providing a therapeutic massage.

2. State of the Art

Deep vein thrombosis (DVT) refers to the formation of a thrombus (blood clot) within a deep vein, commonly in the thigh or calf. The blood clot can travel to the lungs, resulting in pulmonary embolism, a potentially life-threatening condition.

DVT occurs when the flow of blood is restricted in a vein, and can be caused by poor circulation because of problems such as heart disease, a recent heart attack or stroke, varicose veins, or from inactivity or prolonged bed rest. Recently, a lot of attention has been focused on DVT developed during long airplane flights and deaths resulting therefrom. In fact, DVT has been dubbed ‘economy class syndrome’ because the less expensive seats in a plane have less leg room, limited leg movement. However, DVT is not confined to economy class or to long haul flights.

In view of current and impending lawsuits by passengers with respect to DVT, airlines have become proactive in trying to prevent the condition and are now directing passengers to get up and walk around the airplane cabin at least once an hour to increase blood circulation. However, flights are subject to meal service and turbulence which limit the amount of time available for passengers to exercise their legs. Moreover, flights are crowded and it is not feasible for all the passengers to walk through the narrow aisles in the cabin.

As a response, a number of devices are being promoted to increase blood circulation while a passenger remains seated. For example, the LYMPHA-PRESSO SKY WALKER™ device by Mego Afek of Kibbutz Afek, Israel, is a portable, foldable exercise device operated from a seated position. The device includes two foot pedals which are not subject to any resistance other than minimal friction forces. When the user wants to increase circulation, the pedals can be easily moved by the feet of a user in a pedaling motion. The simple pedal movement of the user's feet effects contraction of the calf muscles which assists in moving venous blood back to the heart, augmenting arterial blood inflow and preventing thrombosis.

However, this and similar devices have a common drawback when used for the purpose of preventing DVT on long airplane flights; they require too much effort. Even the SKY WALKERS device, which offers substantially no resistance, requires the user to concentrate on the movement of the feet. That is, if the user concentrates on the in-flight movie or a magazine, it is easy to forget to continue to pedal and DVT can result.

U.S. Pat. No. 6,217,488 to Bernardson discloses another lower leg exerciser which includes a base, foot pedals which rock along a pivot relative to the base, and a motor adapted to rock the pedals back and forth. When feet are placed on the pedals, the feet are rocked automatically and blood circulation in the legs is increased. However, the Bernardson device has several drawbacks. First, the rocking movement of the feet causes the knees to move up and down. This motion is not suited to airplane travel, as the room in front of a seat is limited, and once the user's feet are raised and placed on the device, the rocking motion may cause the user's knees to contact the back of the chair in front, may cause interference with a tray table, or may be annoying if, e.g., trying read a book held on the lap. A second drawback is that the Bernardson device cannot be reconfigured to a smaller size for increased portability.

My previously incorporated prior application, which is parent hereto, describes a foot mobility device having a body, two pedals rotatable about a common axis preferably in opposition to each other and relative to the body, and a motor drive assembly coupled to the pedals. The feet of a user are placed on the pedals, and the motor drive assembly is powered to cause movement of the pedals even while the user is completely passive; i.e., without any active participation by the user. Moreover, the sensation received by the use, rather than being one of typical “exercise”, is massage-like and therapeutic, all while providing the same benefit of increased blood circulation due to contraction and relaxation of the calf muscle. Moreover, the foot mobility device may be moved between an open configuration adapted for use of the device and a collapsed configuration having a low profile and adapted for storage and portability.

According to one embodiment, the foot mobility device includes a generally vertically oriented body, two foot pedals hingedly coupled on either side of the body to rotate substantially ninety degrees relative to the body between a closed position in which each foot pedal is substantially parallel to the body and an open position in which each foot pedal is substantially perpendicular to the body. In the open position, the pedals are adapted to cause feet placed thereon to rotate about the ankle joint.

According to other embodiments, the foot mobility device includes a preferably flat base, two pedals rotatable about a heel pivot, and a motor mechanism which rotates the pedals. The motor mechanism is movable from a first position in which it lies against the base to an upright second position in which it is adapted to move the pedals. The pedals can be configured to lie flat against the base for storage and portability. In addition, the pedals can preferably be disengaged from the motor drive so that the device can be used as an active exercise device and also to facilitate moving the pedals for folding the device in a highly portable configuration.

### SUMMARY OF THE INVENTION

It is therefore an object of the invention to provide a foot mobility device which moves the feet in a manner which limits knee movement.

It is another object of the invention to provide a foot mobility device which requires no effort on the part of the user.

It is an additional object of the invention to provide a foot mobility device which is portable.

It is also an object of the invention to provide a foot mobility device which has a low profile.

It is still another object of the invention to provide a foot mobility device which has a collapsed configuration.

It is a further object of the invention to provide a foot mobility device which includes foot massaging capability.

It is still another object of the invention to provide a foot mobility device which operates without complex motors and gears.

It is yet another object of the invention to provide a foot mobility device which can be used with one foot alone or in synchronization with both feet.

In accord with these objects, which will be discussed in detail below, a foot mobility device according to the invention includes a base, a foot rest hingedly coupled to the base, and an inflatable lifting bladder between the base and the foot rest. The lifting bladder is coupled by a valve to a source of fluid pressure. The valve is operable to inflate and deflate the lifting bladder thereby raising and lowering the foot rest without the use of a motor and gear assembly. The foot rest preferably has a massage sock coupled to it. The massage sock contains a plurality of inflatable massage bladders, each being coupled by a valve to a source of fluid pressure, each of the valves being operable to inflate and deflate the massage bladders. Each of the bladders is preferably coupled to a pressure sensor which determines the extent to which the bladder has been inflated/deflated.

According to a presently preferred embodiment, the source of fluid pressure is an air pump and a compressed air tank coupled to the valves and a pressure sensor. In the presently preferred embodiment, the valves are electrically operable and the pressure sensors produce electrical signals. A control circuit is electrically coupled to the valves, the sensors, and the pump. The control circuit selectively inflates and deflates the bladders according to a cycle which raises and lowers the foot rest and inflates/deflates the massage bladders. The presently preferred control circuit is a microprocessor, ASIC (application specific integrated circuit), PLA (programmable logic array) or similar circuit which will operate the valves to inflate and deflate the bladders to desired pressures (determined by the sensors) according to a programmed regime. A simple regime is to inflate bladders to 2-3 psi for 20-30 seconds then deflate to 0 psi in an alternating sequence

Also according to the presently preferred embodiment, the control circuit is provided with a synchronization link which is used to electrically couple two foot mobility devices (one for each foot) such that they operate in an alternating rhythm.

The presently preferred massage sock is made of elastic material and provided with a zipper so that it may comfortably a variety of foot sizes. The presently preferred number of massage bladders is seven: two under the heel, two behind the heel, two over the instep, and one under the sole.

Additional objects and advantages of the invention will become apparent to those skilled in the art upon reference to the detailed description taken in conjunction with the provided figures.

### BRIEF DESCRIPTION OF THE DRAWINGS

FIG. 1 is a perspective view of the upper front of a foot mobility device according to the invention;

FIG. 2 is a perspective view of the lower rear of the foot mobility device;

FIG. 3 is a top plan view of the foot mobility device;

FIG. 4 is a front side elevational view of the foot mobility device;

FIG. 5 is a perspective view of two foot mobility devices and a synchronization cable; and

FIG. 6 is a schematic diagram of the electrical and pneumatic components of the foot mobility device.

### DETAILED DESCRIPTION OF THE PREFERRED EMBODIMENTS

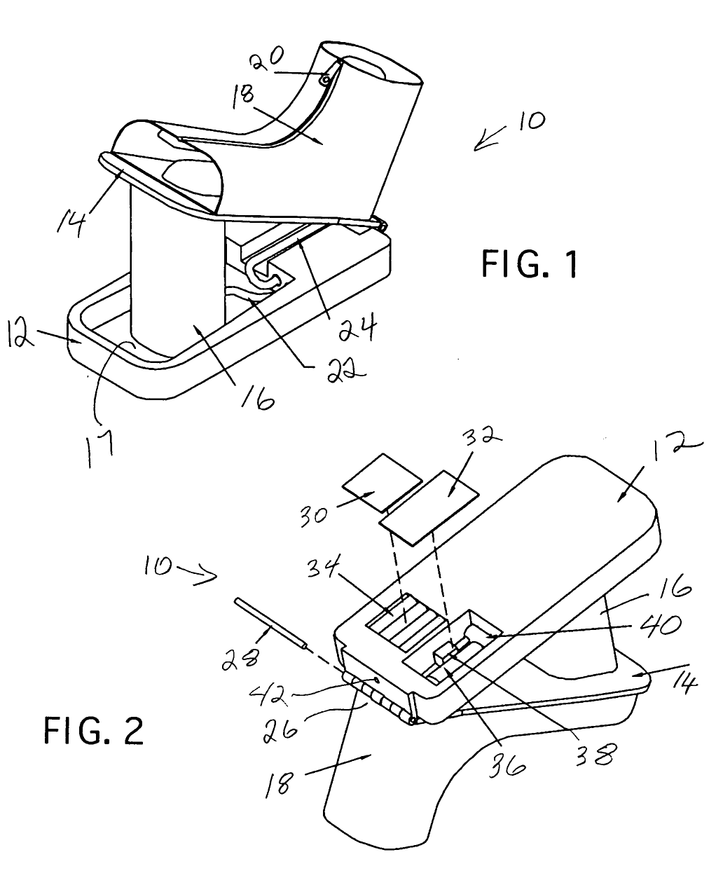

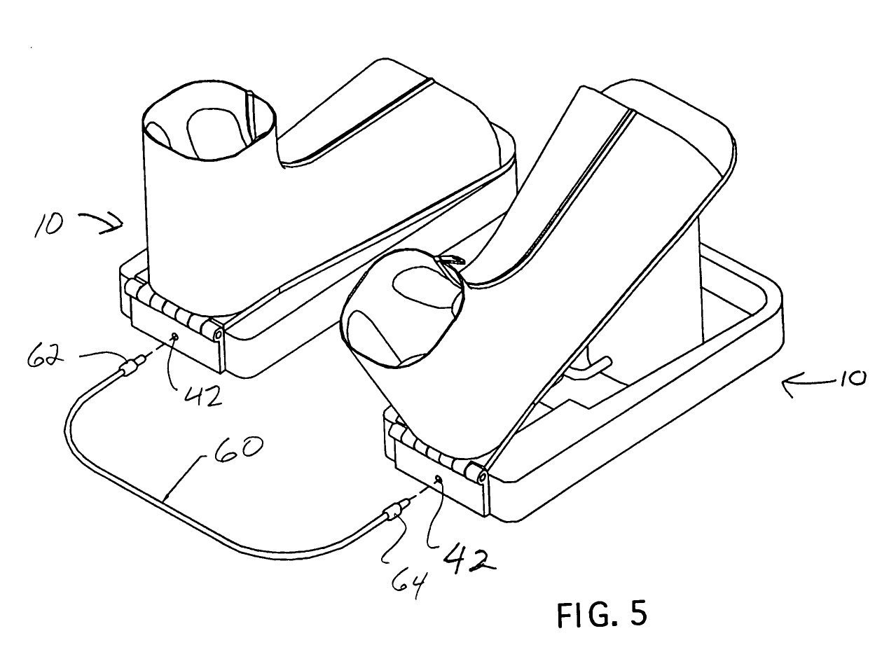

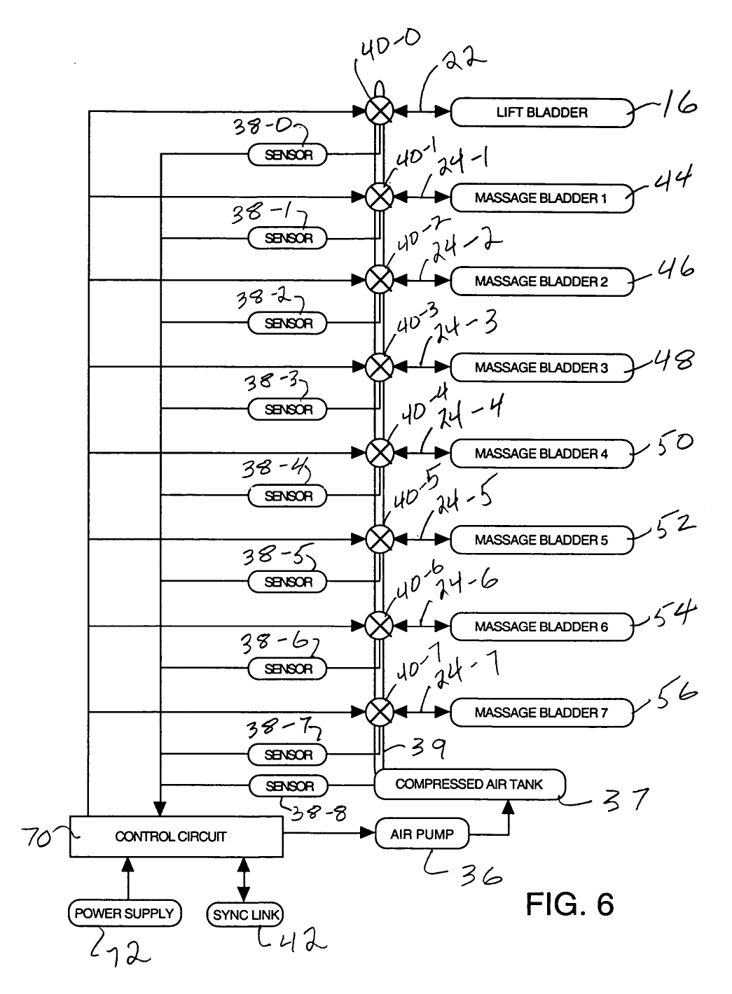

Turning now to FIGS. 1 and 2, a foot mobility device 10 according to the invention includes a base 12, a foot rest 14 hingedly coupled to the base 12, and an inflatable lifting bladder 16 between the base 12 and the foot rest 14. As described in more detail below with reference to FIG. 6, the lifting bladder 16 is coupled by a valve to a source of fluid pressure and the valve is operable to inflate and deflate the lifting bladder thereby raising (see FIG. 1) and lowering (see FIG. 4) the foot rest 14 without the use of a motor and gear assembly. When the bladder 16 is deflated it collapses into the well 17 in the base 12 permitting the foot rest 14 to lie flus with the base.

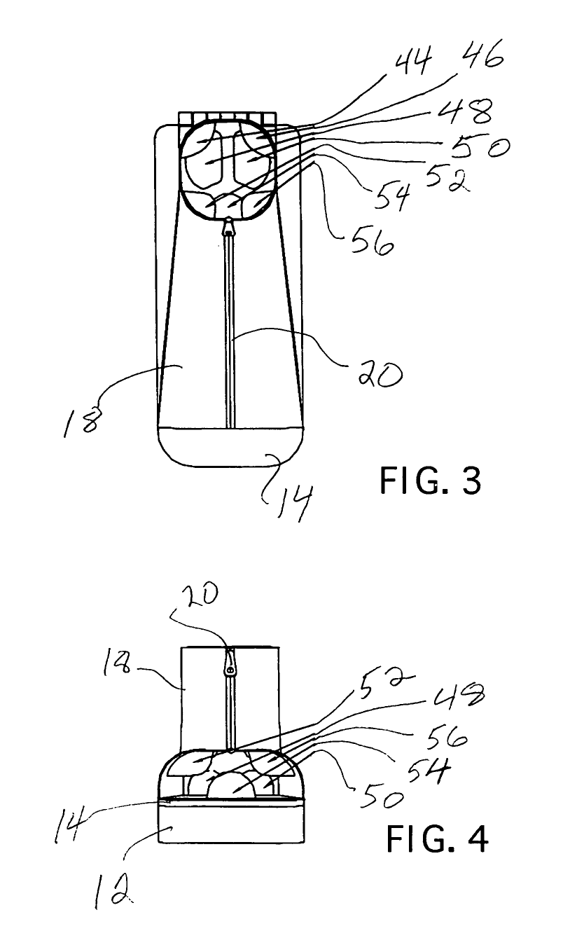

The foot rest 14 preferably has a massage sock 18 coupled to it. The massage sock contains a plurality of inflatable massage bladders which are described in more detail below with reference to FIGS. 3, 4, and 6. As seen in FIG. 1, the massage sock 18 has a zipper 20 which facilitates attachment of the sock to the user's foot. FIG. 1 also illustrates a fluid conduit 22 for inflating the lifting bladder 16 and a fluid conduit 24 for inflating the massage bladders.

FIG. 2. illustrates the hinge coupling which includes the interleaved members 26 and the hinge pin 28. FIG. 2 further shows that the base 12 has removable access panels 30, 32. The panel 30 exposes a battery compartment 34 for batteries (not) shown) to power the control circuit described below. The panel 32 exposes operational equipment such as an air pump 36, a pressure sensor 38, and an electrically operated valve 40. An electrical connector 42 is also shown in FIG. 2. This connector is described in more detail below with reference to FIGS. 5 and 6.

Referring now to FIGS. 3 and 4, the illustrated embodiment of the massage sock 18 includes seven inflatable massage bladders: two under the heel 48, 50, two behind the heel 44, 46, two over the instep 52, 56, and one under the sole 54. Although FIG. 1 suggests that all of the massage bladders are inflated from a single fluid conduit 24, separate conduits may be provided for each bladder. As mentioned above, the base 12 of the foot mobility device 10 includes a control circuit (not shown in FIGS. 1-5) which operates the air pump 36 and valve(s) 40 to inflate and deflate the bladders according to a programmed regime.

Turning now to FIG. 5, the foot mobility device 10 is preferably used together with an identical mate. The control circuits of each device 10 are coupled to each other via the electrical connectors 42 and a synchronization cable 60. The cable is provided with two n-pin electrical connectors 62, 64 which mate with connectors 42. When two foot mobility devices are operated together, it is advantageous that one act as master and the other as slave. This can be automatically determined by the connectors 62, 64 on the cable 60. For example, one of the connectors 62, 64 can have two of its n-pins jumpered together whereas the other connector does not have any pins jumpered together. The foot mobility device which receives the connector having the jumpered pins will sense the jumpered pins and in response will act as either a master or slave, whichever is predetermined by the circuit designer. When the foot mobility devices act in master-slave relationship, one possible synchronization scheme is that the slave will wait for a signal from the master before starting the regime.

Referring now to FIG. 6, an exemplary embodiment of a control circuit is illustrated in conjunction with the aforementioned bladders, air pump, valve and sensor. In this embodiment, the air pump 36 is coupled to a compressed air tank 37 which feeds a compressed air distribution conduit 39. Each of the bladders is coupled by an electrically operated valve to the conduit 39. For example, the lifting bladder 16 is coupled via conduit 22 to valve 40-0 which is coupled to the conduit 39. The massage bladders 44-56 are similarly coupled via conduits 24-1-24-7 to valves 40-1-40-7 to the conduit 39. Each of the valves is also coupled to an electrical pressure sensor 38-0-38-7 which monitor the pressure in each of the bladders. The compressed air tank 37 is also coupled to a pressure sensor 38-8. All of the valves and sensors are coupled to a control circuit 70 which is also coupled to the air pump 36, a power supply 72 and a synchronization link 42 (previously referred to an electrical connector).

The control circuit 70 operates the air pump 36 to fill the air tank 37 and selectively operates the valves to inflate and deflate the bladders according to a cycle which raises and lowers the foot rest and inflates/deflates the massage bladders. The presently preferred control circuit is a microprocessor, ASIC (application specific integrated circuit), PLA (programmable logic array) or similar circuit which will operate the valves to inflate and deflate the bladders to desired pressures (determined by the sensors) according to a programmed regime. A simple regime is to inflate bladders to 2-3 psi for 20-30 seconds then deflate to 0 psi in an alternating sequence.

The circuit shown in FIG. 6 may be considered “deluxe”. According to simpler embodiments of the invention, fewer valves and sensors may be provided and bladders may be inflated and deflated in groups, rather than individually. It will also be appreciated that the number of massaging bladders may be greater than or fewer than the seven illustrated bladders. The power supply 72 may be a battery or a group of batteries. The battery may be rechargeable, and an AC adapter may be provided to avoid battery consumption/depletion. The present invention contemplates that the massage sock with massage bladders may be used in conjunction with my earlier device which is disclosed in the parent application or in conjunction with other foot rest lifting means.

There have been described and illustrated herein embodiments of a powered foot mobility device. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope.

What is claimed is:

1. A foot mobility device, comprising:
a base;
a foot rest hingedly coupled to the base;
an inflatable lifting bladder located between the base and the foot rest, said lifting bladder, when inflated, causing said foot rest to rotate relative to said base;
at least one foot massage bladder coupled to the foot rest; and
a pressure source selectively coupled to each of the bladders.

2. A foot mobility device according to claim 1, further comprising:
a massage sock coupled to said foot rest, said foot massage bladder being contained within said massage sock.

3. A foot mobility device according to claim 2, wherein:
said massage sock includes a zipper.

4. A foot mobility device according to claim 1, wherein:
said foot massage bladder includes a plurality of massage bladders.

5. A foot mobility device according to claim 4, wherein:
said plurality of massage bladders includes at least one heel massage bladder, at least one instep massage bladder, and at least one sole massage bladder.

6. A foot mobility device according to claim 1, further comprising:
means for individually inflating and deflating each of said bladders.

7. A foot mobility device according to claim 4, further comprising:
means for individually inflating and deflating each of said bladders.

8. A foot mobility device according to claim 5, further comprising:
means for individually inflating and deflating each of said bladders.

9. A foot mobility device according to claim 1, further comprising:
a plurality of electrically operated valves, wherein
said pressure source is selectively coupled to said bladders via said valves.

10. A foot mobility device according to claim 9, further comprising:
a plurality of pressure sensors corresponding in number to said bladders, each pressure sensor coupled to a corresponding bladder.

11. A foot mobility device according to claim 10, further comprising:
a control circuit coupled to said valves and said pressure sensors.

12. A foot mobility device, comprising:
a base;
a foot rest hingedly coupled to the base;
lifting means located between the base and the foot rest for raising and lowering said foot rest relative to said base;
at least one foot massage bladder coupled to the foot rest; and
a pressure source selectively coupled to each of the at least one massage bladders.

13. A foot mobility device according to claim 12, further comprising:
a massage sock coupled to said foot rest, said foot massage bladder being contained within said massage sock.

14. A foot mobility device according to claim 13, wherein:
said massage sock includes a zipper.

15. A foot mobility device according to claim 12, wherein:
said foot massage bladder includes a plurality of massage bladders.

16. A foot mobility device according to claim 15, wherein:
said plurality of massage bladders includes at least one heel massage bladder, at least one instep massage bladder, and at least one sole massage bladder.

17. A foot mobility device according to claim 15, further comprising:
means for individually inflating and deflating each of said bladders.

18. A foot mobility device according to claim 16, further comprising:
means for individually inflating and deflating each of said bladders.

19. A foot mobility device according to claim 15, further comprising:
a plurality of electrically operated valves, wherein
said pressure source is selectively coupled to said bladders via said valves.

20. A foot mobility device according to claim 19, further comprising:
a plurality of pressure sensors corresponding in number to said bladders, each pressure sensor coupled to a corresponding bladder.

21. A foot mobility device according to claim 20, further comprising:
a control circuit coupled to said valves and said pressure sensors.
